(19) United States
(12) Patent Application Publication
(10) Pub. No.: US 2016/0135488 A1
(43) Pub. Date: May 19, 2016

(54) METHOD FOR PREPARING OAT NOODLE

(71) Applicant: Sang Eun LEE, Gangwon-do (KR)

(72) Inventor: Sang Eun LEE, Inje-gun, Gangwon-do (KR)

(21) Appl. No.: 14/896,195

(22) PCT Filed: Apr. 17, 2014
(86) PCT No.: PCT/KR2014/003381

§ 371 Date: Dec. 4, 2015

(30) Foreign Application Priority Data
Apr. 19, 2013 (KR) 10-2013-0043413
Apr. 8, 2014 (KR) 10-2014-0042067

(51) Int. Cl. A23L 1/16; A21C 11/16

(52) U.S. Cl. CPC A23L 1/16; A23V 2002/00

(57) ABSTRACT

A method for preparing buckwheat noodles capable of preparing noodles using only 100% pure buckwheat includes a soaking step of soaking buckwheat grain in water at room temperature, a heating step of boiling the buckwheat grain undergoing the soaking step, a husk separation step of separating the buckwheat grain undergoing the heating step into endosperm and husks and adding salt water to the endosperm, a kneading and aging step of kneading and aging the endosperm with which the salt water is mixed through the husk separation step to make dough, a noodle making step of making buckwheat noodles by extruding the dough through a noodle-making machine, a reheating step of reheating the buckwheat noodles prepared through the noodle making step by steaming, and a cooling and drying step of cooling and drying the reheated buckwheat noodles.

### BACKGROUND OF THE INVENTION

1. Field of the Invention

The present invention relates to a method for preparing buckwheat noodles capable of preparing noodles using only 100% pure buckwheat without using starch such as wheat flour or starch flour, thereby enjoying unique natural taste and texture of buckwheat.

2. Description of the Related Art

Buckwheat grows well in cold climates, may be harvested within 60 to 100 days after buckwheat seeds are sowed, and also grows well in and lands. For these reasons, buckwheat has been used as an emergency food from ancient times.

Buckwheat blooms, and bears seeds having trapezoidal black husks. The seeds are milled to remove the husks, and an endosperm fraction in the seeds is ground into flour, which is referred to as buckwheat flour. When the center of the endosperm fraction is ground into flour, the flour has the whitest color. In this case, the flour turns darker and has better flavor as it is ground more finely. In particular, buckwheat has a good flavor immediately after milling. Even when buckwheat which has been sufficiently dried is kept in a cold place for 4 to 6 months, it does not lose its flavor. Buckwheat is initially sticky, but is easily broken when heat is applied thereto, which makes it difficult to prepare noodles from buckwheat flour. To make noodles, buckwheat flour and wheat flour are mixed in a ratio of 7:3, and other ingredients such as bean flour, starch, eggs, phosphate, and water are mixed for use.

Buckwheat noodles are parboiled in boiling water, rinsed with cold water, and put onto a colander to remove water. Then, buckwheat noodles are mixed with a hot soybean broth, or eaten as naengmyeon (hereinafter referred to as cold noodles in Korea). Especially, cold noodles are prepared by cooling a broth such as a beef brisket broth or a chicken broth, mixing buckwheat noodles with the broth, and garnishing the buckwheat noodles with pressed and sliced beef brisket, thinly sliced fried egg, etc., and thus taste especially good in cold seasons. Makguksu prepared by putting buckwheat noodles in cold Kimchi juice and garnishing the buckwheat noodles with Kimchi or cucumber pickles is also famous in Korea.

Buckwheat is a good food of high nutritive value, and has a protein content of 12 to 14%, the content of which is higher than those of other cereals. In addition, such a protein is excellent in nutritional aspects since it has a high content of lysine as an essential amino acid. In addition, the protein has a high content of rutin which is effective in enhancing capillary resistance and preventing blood vessel injuries such as cerebral hemorrhage caused by hypertension.

The content of buckwheat is most important for buckwheat noodles, but most buckwheat noodles prepared in Korea have a buckwheat content of 10 to 20%. In this case, a brown or black pigment is added to buckwheat noodles so that the buckwheat noodles become blackish. Typically, since buckwheat has a drier texture with increase in the content thereof, starch is mixed with buckwheat so that the buckwheat has a crispy texture. However, it is important for buckwheat noodles to have a unique flavor as well as a chewy texture. In recent years, users tend to often have buckwheat noodles in which buckwheat is present in a content of 70% or more so that the buckwheat noodles have a very dry texture but to enjoy a spicy taste of buckwheat itself.

However, since buckwheat does not have a sufficient viscosity, it is impossible to make noodles using only 100% buckwheat grain. Therefore, buckwheat has to be mixed with starch, such as wheat flour or starch flour, which contains large amounts of gluten components, which makes it impossible for consumers to truly enjoy the unique crispy taste of buckwheat.

### RELATED ART DOCUMENT

### Patent Document

Patent Document 0001: Korea Laid-Open Patent Application No. 1993-0001806 (published on Jan. 22, 1993) entitled “Process for making buckwheat noodles”

### SUMMARY OF THE INVENTION

Therefore, the present invention has been made in view of the above problems, and it is an object of the present invention to provide a method for preparing buckwheat noodles capable of preparing noodles using only 100% pure buckwheat without using starch such as wheat flour or starch flour, thereby enjoying unique natural taste and texture of buckwheat.

In accordance with the present invention, the above and other objects can be accomplished by the provision of a method for preparing buckwheat noodles, which includes a soaking step of soaking buckwheat grain in water at room temperature, a heating step of boiling the buckwheat grain undergoing the soaking step, a husk separation step of separating the buckwheat grain undergoing the heating step into endosperm and husks and adding salt water to the endosperm; a kneading and aging step of kneading and aging the endosperm with which the salt water is mixed through the husk separation step to make dough; a noodle making step of making buckwheat noodles by extruding the dough through a noodle-making machine; a reheating step of reheating the buckwheat noodles prepared through the noodle making step by steaming; and a cooling and drying step of cooling and drying the reheated buckwheat noodles.

In this case, the soaking step may include soaking the buckwheat grain in water at room temperature for 50 to 60 minutes, the heating step may include putting water into a pressure cooker in an amount of 120 to 130 parts by weight based on 100 parts by weight of the buckwheat grain, and boiling the buckwheat grain over medium heat for 4 to 6 minutes, high heat for 4 to 6 minutes, and low heat for 10 to 12 minutes to steam the buckwheat grain thoroughly, and the husk separation step may further include adding salt water, in which 0.4 to 15 parts by weight of salt is mixed with 15 to 25 parts by weight of water, to the endosperm from which the husks are separated.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flowchart illustrating the respective steps of a method for preparing buckwheat noodles according to one embodiment of the present invention.

### DETAILED DESCRIPTION OF THE INVENTION

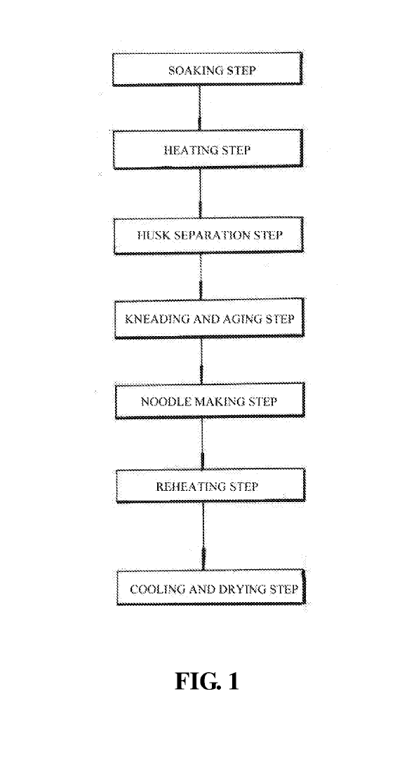

As shown in FIG. 1, a method for preparing buckwheat noodles according to one embodiment of the present invention includes a soaking step, a heating step, a husk separation step, a kneading and aging step, a noodle making step, a reheating step, and a cooling and drying step, and such respective steps will be described in detail, as follows.

### Soaking Step

Buckwheat grain is soaked in water at room temperature for 50 to 60 minutes to soften husks of the buckwheat grain. In this case, when the buckwheat grain is soaked in water for 60 to 120 minutes, water permeates the endosperm of the buckwheat grain. Therefore, the buckwheat grain may be overgelatinized since heat is rapidly transferred to the endosperm of the buckwheat grain by means of water, which has permeated the endosperm of the buckwheat grain, in a heating step as will be described below. As a result, the buckwheat grain may be in a paste state like gruel.

On the other hand, when the buckwheat grain is soaked for a period of time shorter than 50 minutes, the husks are not sufficiently softened, and thus continue to be firmly attached to the endosperm. As a result, the husks are not easily separated from the endosperm in a husk separation step as will be described below, resulting in loss of the endosperm and difficulties in handling.

### Heating Step

This heating step involves boiling the buckwheat grain undergoing the soaking step. Here, the buckwheat grain is boiled in a pressure cooker like cooking rice. Specifically, water is added to a pressure cooker in an amount of 120 to 140 parts by weight, based on 100 parts by weight of buckwheat grain, so that heat is applied to the pressure cooker. Thereafter, the buckwheat grain is boiled over medium heat for 4 to 6 minutes, high heat for 4 to 6 minutes, and low heat for 10 to 12 minutes to steam the buckwheat grain thoroughly.

In this case, when the water is present in an amount of greater than 140 parts by weight, the buckwheat grain may be overgelatinized due to high viscosity, and thus may be in a paste state like gruel, which makes it impossible to form noodles in a noodle making step as will be described below. On the other hand, when the water is present in an amount of less than 120 parts by weight, the buckwheat grain may be poorly gelatinized, and thus the viscosity of the buckwheat grain may be lowered, which makes it impossible to form noodles in a noodle making step as will be described below. Accordingly, it is important that the water be mixed in an amount of 120 to 140 parts by weight, based on 100 parts by weight of the buckwheat grain.

### Husk Separation Step

This husk separation step involves removing husks from the endosperm of the buckwheat grain gelatinized through the heating step to make dough only made of the buckwheat endosperm. In this case, since the buckwheat grain is already gelatinized and cooked through the heating step, the husks are left behind on the filter net, and only the endosperm drops through the filter net when the gelatinized buckwheat grain is placed and violently rubbed on a filter net. As a result, only the endosperm from which the husks are removed may be collected.

Salt water is added to the endosperm of the buckwheat grain thus collected to have a structure of noodle strands, that is, to have properties of noodles such as elasticity, flexibility, and mouthfeel. In this case, the salt water is prepared by mixing 0.4 to 15 parts by weight of salt with 15 to 25 parts by weight of water, based on 100 parts by weight of the buckwheat grain. Here, the water is water remaining from a total of 135 to 165 parts by weight of water used to boil the buckwheat grain.

Here, salt absolutely serves to prepare noodles having a well-preserved shape and good elasticity. That is, salt has a property of hardening gluten and enhancing elasticity of gluten, and serves to sufficiently connect the entire tissues, thereby allowing dough to have elasticity. In addition, salt serves to stabilize a protein component (i.e., gluten) in noodles and preserve moisture in the dough.

### Kneading and Aging Step

The endosperm mixed with the salt water is lumped into mass, and kneaded to make dough. Thereafter, the dough is aged at room temperature, that is, a temperature of 15 to 20° C. for 1 to 2 hours, and kneaded again to prepare dough to be actually put into a noodle-making machine. As such a cycle of kneading and aging is repeatedly performed, the moisture included in the dough and the salt water added to the dough may be uniformly distributed inside and outside molecules and particles of the dough to stabilize the dough, and the endosperm and fibers in the dough may be aged to improve viscosity and softness as well.

### Noodle Making Step

This noodle making step involves putting the prepared dough into a noodle-making machine to prepare noodles. Typically, the noodle-making machine includes a nozzle having a surface having a plurality of extrusion holes formed therein to determine a thickness of noodles, and a screw provided at the rear side of the nozzle to forcibly extrude the dough put into the noodle-making machine. Here, the screw is configured so that the exterior of the screw can be protected by an outer body provided with an inlet port. When the dough of the present invention is put into such a noodle-making machine and the noodle-making machine is operated, the dough is forcibly transferred to a side of the nozzle by rotation of the screw, and noodle strands are drawn through the extrusion holes formed in the nozzle, thereby preparing noodles.

### Reheating Step

This reheating step involves reinforcing a texture of the buckwheat noodles prepared through the noodle making step to continuously maintain a constant shape of the noodle strands for a long period of time. The buckwheat noodles are re-boiled for 15 to 20 minutes by steaming. As a result, the buckwheat noodles may be in an irreversible gelatinized state in which scattered molecules do not return to an original state, thereby reinforcing the texture of the noodles and continuously maintaining the constant shape of the noodles.

### Cooling and Drying Step

This cooling and drying step involves rapidly cooling the reheated noodles to remove surface viscosity of the noodles, and making raw noodles having a chewy texture by suppressing a gelatinization process caused by remaining heat. In this case, when the raw noodles are subjected to a drying step, the raw noodles become dried noodles.

The reheated buckwheat noodles are drawn into noodle strands having different shapes, depending on a content of salt, that is, a content ranging from 0.4 to 15 parts by weight. When the salt is present in an amount of 0.4 to 6 parts by weight, the noodle strands are properly formed by applying hot air using a drying machine. When the salt is present in an amount of 6 to 15 parts by weight, the noodle strands are properly formed under natural drying conditions due to high salt content. In this case, when the content of the salt is greater than 15 parts by weight, product values may be lowered since products are very salty. However, it can be seen that, when the content of the salt is 10 parts by weight, the noodles are not salty, and the noodle strands are properly formed.

As apparent from the above description, the present invention provides a method for preparing buckwheat noodles capable of preparing chewy noodles having elasticity and stickiness using only 100% pure buckwheat without using starch such as wheat flour or starch flour, thereby enjoying unique natural taste and texture of buckwheat. Here, the method according to one embodiment of the present invention includes soaking buckwheat grain in water to soft only husks of the buckwheat grain, boiling the buckwheat grain to be gelatinized, separating the husks from the buckwheat grain, adding salt water thereto to prepare noodles, reheating the noodles, and cooling and drying the reheated noodles.

Although the method for preparing buckwheat noodles according to the preferred embodiments of the present invention have been disclosed for illustrative purposes, those skilled in the art will appreciate that various modifications, additions and substitutions are possible, without departing from the scope and spirit of the invention as disclosed in the accompanying claims.

1-4. (canceled)

5. A method for preparing buckwheat noodles, comprising:
a soaking step of soaking buckwheat grain in water at room temperature;
a heating step of boiling the buckwheat grain undergoing the soaking step;
a husk separation step of separating the buckwheat grain undergoing the heating step into endosperm and husks and adding salt water to the endosperm;
a kneading and aging step of kneading and aging the endosperm with which the salt water is mixed through the husk separation step to make dough;
a noodle making step of making buckwheat noodles by extruding the dough through a noodle-making machine;
a reheating step of reheating the buckwheat noodles prepared through the noodle making step by steaming; and
a cooling and drying step of cooling and drying the reheated buckwheat noodles.

6. The method according to claim 5, wherein the soaking step comprises soaking the buckwheat grain in water at room temperature for 50 to 60 minutes.

7. The method according to claim 5, wherein the heating step comprises putting water into a pressure cooker in an amount of 120 to 130 parts by weight based on 100 parts by weight of the buckwheat grain, and boiling the buckwheat grain over medium heat for 4 to 6 minutes, high heat for 4 to 6 minutes, and low heat for 10 to 12 minutes to steam the buckwheat grain thoroughly.

8. The method according to claim 5, wherein the husk separation step further comprises adding salt water, in which 0.4 to 15 parts by weight of salt is mixed with 15 to 25 parts by weight of water, to the endosperm from which the husks are separated.
